(19) United States
(12) Patent Application Publication
(10) Pub. No.: US 2003/0197784 A1
(43) Pub. Date: Oct. 23, 2003

(54) Device and method for displaying a zoom screen in a mobile communication terminal

(76) Inventor: Seung-Gyun Bae, Kumi-shi (KR)

Correspondence Address: Peter L. Kendall, Roylance, Abrams, Berdo & Goodman, L.L.P., Suite 600, 1300 19th Street, N.W., Washington, DC, 20036, US

(21) Appl. No.: 10/419,817

(22) Filed: Apr. 22, 2003

(30) Foreign Application Priority Data
Apr. 22, 2002 (KR) 2002-22057

(51) Int. Cl. H04N 5/225

(52) U.S. Cl. 348/207.1

(57) ABSTRACT

A device and method for displaying an image in a mobile communication terminal including a camera for capturing image signals, and a display unit for displaying the image having a size different from a size of an image of the captured image signals. In the device, a keypad has keys for providing an image capture mode and screen display modes. A controller generates an image capture control signal when an image capture mode key is inputted, and generates first and second scale control signals respectively corresponding to first and second screen display mode keys. A signal processor processes the image signals received from the camera in a digital format when the image capture control signal is generated. An image processor generates image data based on a screen size of the display unit by reducing pixels of the image signals processed by the signal processor when the first scale control signal is generated, generates image data based on the screen size of the display unit by selecting pixels corresponding to the screen size at set horizontal and vertical display initiation positions when the second scale control signal is generated, and outputs the image data to the display unit.

### PRIORITY

This application claims priority to an application entitled “DEVICE AND METHOD FOR DISPLAYING ZOOM SCREEN IN MOBILE COMMUNICATION TERMINAL”, filed in the Korean Industrial Property Office on Apr. 22, 2002 and assigned Serial No. 2002-22057, the contents of which are incorporated herein by reference.

### BACKGROUND OF THE INVENTION

1. Field of the Invention

The present invention relates to a device and method for displaying image data, and more particularly to a device and method for adjusting a received camera image signal captured according to a size of a display screen of a display unit, and displaying the adjusted image signal.

2. Description of the Related Art

A conventional image processing device includes a camera for capturing an image and a display unit for displaying the image captured by the camera. The camera can use a charge coupled device (CCD) image sensor or a complementary metal oxide semiconductor (CMOS) image sensor. As small-sized camera devices have been developed, the image capturing devices have become miniaturized. The current trend is for mobile communication terminals be equipped with camera devices. A mobile communication terminal can now capture images, display moving and still pictures, and transmit the captured images.

The size of pixels of image signals captured by the camera of the image processing device can be different from the size of image signal pixels, which can be displayed on the display unit. That is, the number of pixels of one screen corresponding to the image signals captured by the camera may be different from the number of pixels of a screen, which can be displayed on the display unit, because the display capacity of the display unit is restricted in the image processing device. For example, the display unit of the mobile communication terminal uses a liquid crystal display (LCD). The display unit capable of being attached to the mobile communication terminal depends on the size of the terminal. Thus, there is a problem in that all pixels of the image signals read from the camera cannot be completely displayed on the display unit provided in the terminal. Moreover, where the number of pixels of one screen corresponding to the image signals captured by the camera can be different from the number of pixels of a screen, which can be displayed on the display unit, it is preferable that the pixels of the one screen corresponding to the image signals captured by the camera are scaled based on the size of the display screen of the display unit.

### SUMMARY OF THE INVENTION

Therefore, the present invention has been made in view of the above problem, and it is an object of the present invention to provide a device and method capable of adjusting an image signal of one screen captured by a camera provided in a mobile communication terminal to an image signal of a screen of a display unit, and displaying the adjusted image signal.

It is another object of the present invention to provide a device and method capable of adjusting the number of pixels of image signals captured by a camera provided in a mobile communication terminal where a size of pixels of image signals of one screen captured by the camera is different from that of pixels of image signals of a screen capable of being displayed on a display unit, and displaying the adjusted image signal pixels.

It is yet another object of the present invention to provide a device and method capable of displaying image signals captured by a camera on a zoom screen in a mobile communication terminal.

In accordance with one aspect of the present invention, the above and other objects can be substantially accomplished by the provision of a device for displaying an image in a mobile communication terminal including a camera for capturing image signals, and a display unit for displaying the image having a size different from a size of an image of the captured image signals. The device comprises a keypad having keys for providing an image capture mode and screen display modes; a controller for generating an image capture control signal when an image capture mode key is inputted, and generating first and second scale control signals respectively corresponding to first and second screen display mode keys; a signal processor for processing the image signals received from the camera in a digital format when the image capture control signal is generated; and an image processor for generating image data based on a screen size of the display unit by reducing pixels of the image signals processed by the signal processor when the first scale control signal is generated, generating image data based on the screen size of the display unit by selecting pixels corresponding to the screen size at set horizontal and vertical display initiation positions when the second scale control signal is generated, and outputting the image data to the display unit.

Another aspect of the present invention, provides a method for displaying an image in a mobile communication terminal including a camera and a display unit having a display size different from a size of an image of image signals captured by the camera, comprising the steps of: (a) allowing the camera to capture the image signals; (b) reducing pixels of the image signals captured by the camera according to a screen size of the display unit and displaying the reduced pixels, when a first scale control signal is generated; and (c) selecting some pixels of a predetermined area from the pixels of the captured image signals and displaying the selected pixels on a zoom screen, when a second scale control signal is generated.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating an example of components for a mobile communication terminal in accordance with an embodiment of the present invention;

FIG. 2 is a block diagram illustrating an example of the components of a signal processor shown in FIG. 1 in accordance with an embodiment of the present invention;

FIG. 3 is a block diagram illustrating an example of the components of an image processor shown in FIG. 1 in accordance with an embodiment of the present invention;

FIG. 4 is a data signal diagram illustrating an example of a procedure of transmitting an image signal from a camera in an image processing device in accordance with an embodiment of the present invention;

FIG. 5 is a diagram illustrating an example of an operation of a scaler shown in FIG. 3 in accordance with an embodiment of the present invention; and

FIG. 6 is a flow chart illustrating an example of steps for performing a zoom function in the image processing device in accordance with an embodiment of the present invention.

### DETAILED DESCRIPTION OF THE PREFERRED EMBODIMENTS

Several embodiments of the present invention will be described in detail with reference to the accompanying drawings. In the drawings, the same or similar elements are denoted by the same reference numerals.

Those skilled in the art will appreciate that specific criteria such as a size of pixels of image signals captured by a camera, a size of pixels of image signals capable of being displayed on a display unit, a transmission rate of an image signal, and so on are described only for illustrative purposes to help in understanding the present invention. The present invention can also be implemented without those specific criteria.

It is also noted that the term “image capture mode” refers to an operating mode for capturing image signals through a camera and displaying the captured image signals on a display unit. The term “enlarged screen display mode” refers to an operating mode for enlarging pixels of the captured image signals in the image capture mode and displaying the enlarged pixels on the display unit. The term “first scale control signal” refers to a control signal for reducing the number of image signals captured by the camera and displaying the reduced image signals on a screen of the display unit. The term “second scale control signal” refers to a control signal for selecting some image signals of a specified area from the image signals captured by the camera and displaying the selected image signals on a zoom screen. The term “first display screen” refers to a screen for displaying reduced pixels of the image signals captured by the camera in response to the first scale control signal, and the term “second display screen” refers to a screen for selecting predetermined image pixels from an image of the image signals captured by the camera in response to the second scale control signal and displaying the selected image pixels on the zoom screen. The term “preview” refers to an operation of displaying the image signals captured by the camera in the form of a moving picture. The term “still-picture capture mode” refers to an operating mode for capturing a still picture in a preview state.

It is assumed that a device for capturing and displaying an image according to a peripheral luminous intensity is a mobile communication terminal in accordance with embodiments of the present invention. However, the device and method in accordance with the embodiments of the present invention can be applied to any conventional image processing device for displaying an image using a camera and is not limited to the mobile communication terminal described herein.

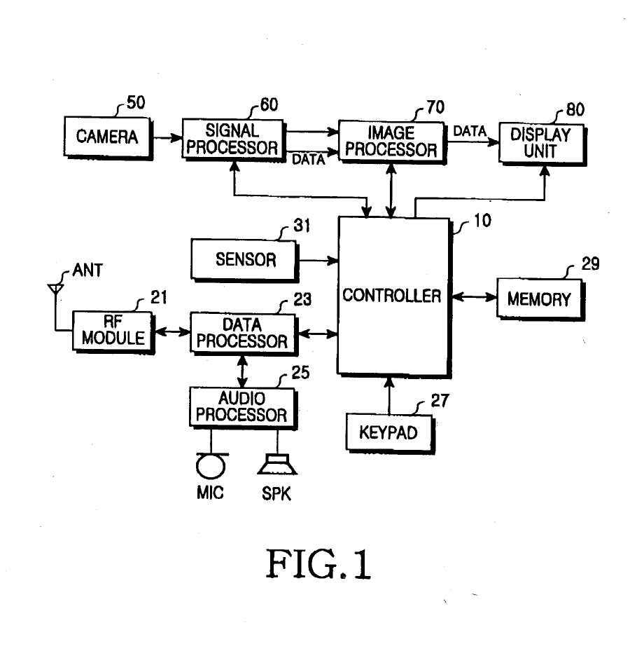

FIG. 1 is a block diagram illustrating an example of components for an image processing device in accordance with the present invention, wherein the image processing device can be a mobile communication terminal.

Referring to FIG. 1, a radio frequency (RF) module 21 performs communications for the mobile communication terminal. The RF module 21 includes an RF transmitter (not shown) for up-converting and amplifying a frequency of a signal to be transmitted, an RF receiver (not shown) for carrying out low noise amplification for a received signal and down-converting a frequency of the amplified received signal, and so on. A data processor 23 includes a transmitter (not shown) for encoding and modulating the transmission signal, a receiver (not shown) for demodulating and decoding the received signal, and so on. That is, the data processor 23 can be configured by a modem and a coder/decoder (codec). An audio processor 25 reproduces via the speaker (SPK) an audio signal received from the data processor 23, or transmits an audio signal from a microphone (MIC) to the data processor 23.

A keypad 27 includes keys for inputting numeric and character information and function keys for setting various functions. The keypad 27 further includes a mode setting key, an image capture key, etc. for capturing and displaying an image according to a peripheral luminous intensity in an embodiment of the present invention. A memory 29 and comprises a program memory and a data memory. The program memory stores programs for controlling a general operation of the mobile communication terminal and programs for capturing and displaying the image according to the peripheral luminous intensity in accordance with an embodiment of the present invention. The data memory temporarily stores the data generated while the programs are performed.

The controller 10 controls the operation of the mobile communication terminal. In an embodiment of the present invention, the controller 10 can include the data processor 23. In accordance with another embodiment of the present invention, the controller 10 controls a signal processor 60 when an operating mode is changed through the keypad 27, and sets an image capture mode. Moreover, the controller 10 performs a control operation such that captured image data can be displayed according to the set image capture mode. The controller 10 performs a control operation such that the captured image data can be displayed according to a zoom screen request.

A camera 50 captures an image and includes a camera sensor for converting a light signal of the captured image into an electric signal. In an embodiment of the invention, the camera sensor can be a charge coupled device (CCD) image sensor. The signal processor 60 converts the image signal received from the camera 50 into digital image data. In an embodiment of the invention, the signal processor 60 can be implemented by a digital signal processor (DSP). An image processor 70 generates screen data for displaying the digital image data received from the signal processor 60. Moreover, the image processor 70 processes the image data received under control of the controller 10 in response to a zoom screen request. A display unit 80 displays the screen data generated by the image processor 70, and displays user data received from the controller 10. The display unit 80 can use a liquid crystal display (LCD). In an embodiment of the invention, the display unit 80 can include an LCD controller, a memory for storing image data, LCD elements, and so on.

An operation of the mobile communication terminal will be described with reference to FIG. 1. If a user performs a dialing operation using the keypad 27 when transmitting a call signal, and sets a communication mode, the controller 10 detects the set communication mode, processes the dialing information received from the data processor 23, converts the dialing information into an RF signal through the RF module 21, and outputs the RF signal via the antenna (ANT). If a called party generates a response signal, the controller 10 detects the response signal from the called party through the RF module 21 and the data processor 23. A voice communication path is established through the audio processor 25, wherein the user can communicate with the called party. In a call signal receiving mode, the controller 10 detects the call signal receiving mode through the data processor 23, and generates a ring signal via the audio processor 25. If the user gives a response to the ring signal, the controller 10 detects the response to the ring signal. Thus, the voice communication path is established through the audio processor 25, such that the user can communicate with the called party. Moreover, where the mobile communication terminal is in a standby mode or performs character communication, the controller 10 controls the display unit 80 such that the display unit 80 displays character data processed by the data processor 23.

The mobile communication terminal captures an image of a person or peripheral environment, and displays or transmits the image. First, the camera 50 is mounted in the mobile communication terminal or connected to the mobile communication terminal at its predetermined external position. That is, the camera 50 can be an internal or external camera. The camera 50 can use a charge coupled device (CCD) image sensor. The image captured by the camera 50 is converted into an electric signal by an internal CCD image sensor, and the electric signal is applied to the signal processor 60. The signal processor 60 converts the image signal into digital image data, and outputs the digital image data to the image processor 70.

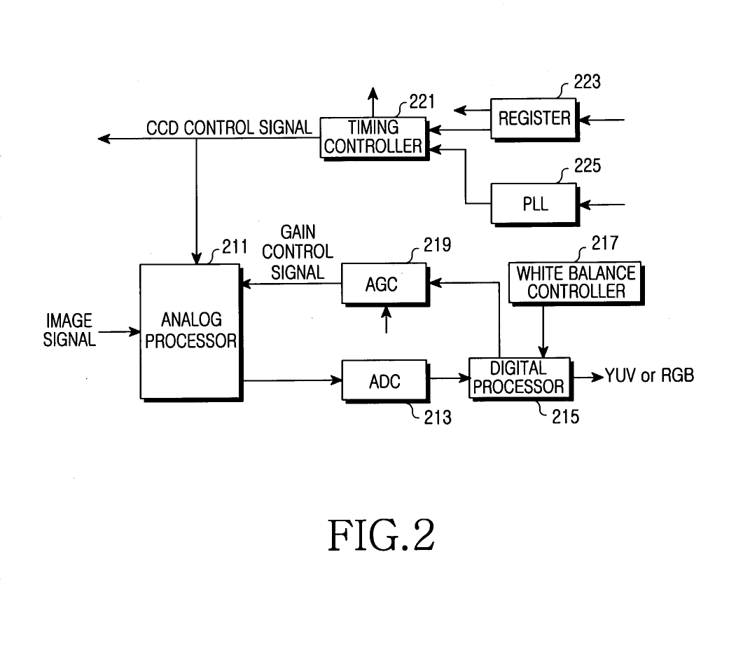

FIG. 2 is a block diagram illustrating an example of the components of the signal processor 60 shown in FIG. 1 in accordance with an embodiment of the invention.

Referring to FIG. 2, an analog processor 211 receives an analog image signal received from the sensor of the camera 50, and controls the amplification of the image signal in response to a gain control signal. An analog-to-digital converter (ADC) 213 converts the analog image signal received from the analog processor 211 into digital image data and then outputs the digital image data. In an embodiment of the invention, the ADC 213 can be an 8-bit ADC. A digital processor 215 receives an output from the ADC 213, converts the digital image data into YUV or RGB data and outputs the YUV or RGB data. The digital processor 215 includes an internal line memory or frame memory, and outputs the processed image data in units of lines or frames. A white balance controller 217 controls a white balance of light. An automatic gain controller 219 generates the gain control signal for controlling a gain of the image signal in response to a mode control signal written to a register 223, and provides the generated gain control signal to the analog processor 211.

The register 223 stores control data received from the controller 10. A phase-locked loop (PLL) circuit 225 provides a reference clock to control an operation of the signal processor 60. A timing controller 221 receives the reference clock from the PLL circuit 225, and generates a timing control signal to control the operation of the signal processor 60.

An operation of the signal processor 60 will now be described. The camera 50 includes a charge coupled device (CCD) image sensor, and converts a light signal of the captured image into an electric signal and outputs the electric signal. The analog processor 211 processes the image signal received from the camera 50. The analog processor 211 controls a gain of the image signal in response to a gain control signal. An analog-to-digital converter (ADC) 213 converts the analog image signal received from the analog processor 211 into digital image data and then outputs the digital image data. A digital processor 215 includes a memory for storing the image data, converts the digital image data into RGB or YUV image data, and outputs the RGB or YUV image data. The memory for storing the digital image data can be implemented by a line memory storing the image data in units of lines or a frame memory storing the image data in units of frames. It is assumed that the line memory is employed in accordance with an embodiment of the present invention. Moreover, it is assumed that the digital processor 215 converts the digital image data into the YUV image data in accordance with an embodiment of the present invention.

A white balance controller 217 generates a control signal for controlling a white balance of the image signal. The digital processor 215 adjusts a white balance of the processed image data. An automatic gain controller (AGC) 219 generates a signal for controlling a gain of the image signal and applies the gain control signal to the analog processor 211. A register 223 stores a mode control signal received from the controller 10. A phase-locked loop (PLL) circuit 225 generates a reference clock signal used in the signal processor 60. A timing controller 221 generates various control signals for the signal processor 60 in response to the reference clock signal received from the PLL circuit 225.

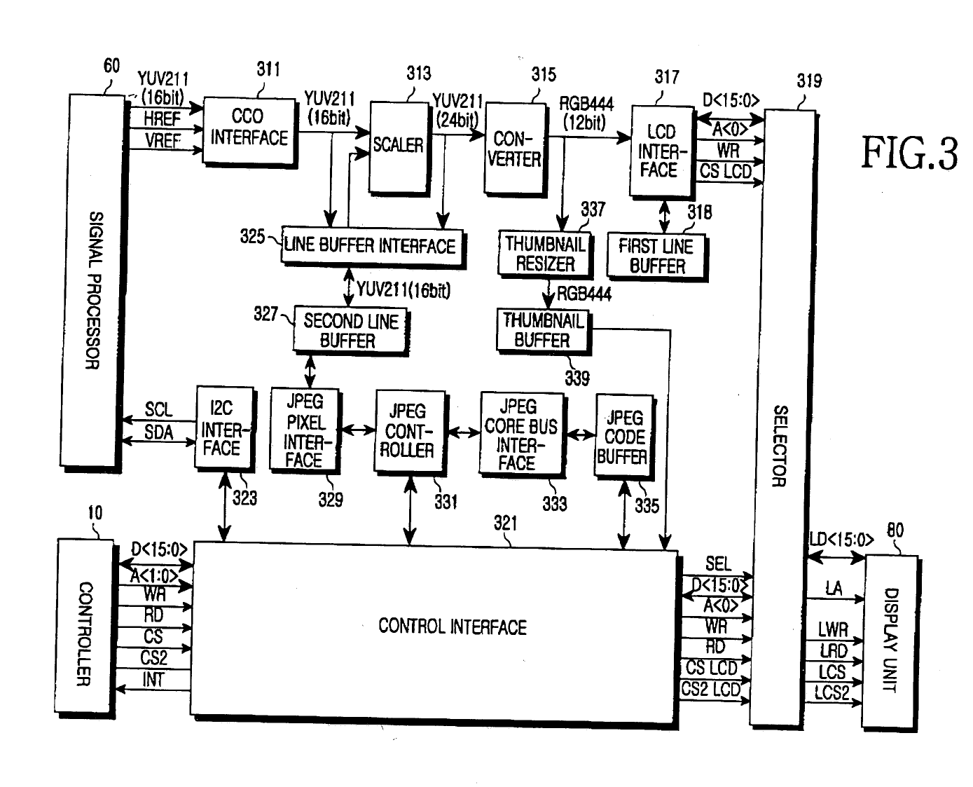

FIG. 3 is a block diagram illustrating an example of the components of the image processor 70 shown in FIG. 1 in accordance with an embodiment of the present invention.

Referring to FIG. 3, the image processor 70 of FIG. 1 interfaces image data between the signal processor 60 and the display unit 80, and compresses and decompresses the data of image signals received from the camera 50 in a joint photographic experts group (JPEG) format. The image processor 70 performs an I2C interface and provides a path of control data to the controller 10.

Referring to FIG. 3, the image processor 70 has the following components.

A digital picture processor is configured by a camera interface (hereinafter, referred to as a CCD interface) 311, a scaler 313, a converter 315, a display interface (hereinafter, referred to as an LCD interface) 317 and a first line buffer 318. The digital picture processor interfaces the image signals between the camera 50 and the display unit 80. Typically, the number of pixels of the image signals of one screen received from the camera 50 is different from the number of pixels of image signals of a screen capable of being displayed on the display unit 80. Accordingly, the digital picture processor performs the interface function for the image signals between the camera 50 and the display unit 80. In an embodiment of the present invention, the digital picture processor scales image data of YUV211 or YUV422 format-based 16 bits received from the signal processor 60, and reduces and crops the image data preferably to a size of 128×112 or 128×96 by cutting upper, lower, left and right ends of a picture corresponding to the image data. It is assumed that the digital picture processor converts the processed image data into an RGB444 format and then transmits the converted image data to the display unit 80. Moreover, the digital picture processor of the present invention performs a zoom-in or zoom-out function for the data of the image signals captured by the camera 50 under control of the controller 10.

The CCD interface 311 of the digital picture processor performs an interface for a YUV211 (16 bits) format picture and synchronous signals HREF and VREF. In an embodiment of the invention, the HREF is used as a horizontal valid time flag and a line synchronous signal. The HREF is a signal for reading the image data, stored in a line memory, in units of lines. The line memory is preferably located in the digital processor 215 contained in the signal processor 60. In an embodiment of the invention, the VREF is used as a vertical valid time flag and a frame synchronous signal. The VREF is used as a signal for enabling the signal processor 60 to output data of the image signals captured by the camera 50.

The LCD interface 317 of the digital picture processor can access the image data of the controller 10 and the digital picture processor using a switching function of a selector 319. In relation to the LCD interface 317 or the display unit 80, D<15:0> or LD<15:0> indicates a data bus. Except where data is read from the display unit 80 or LRD is asserted, the data bus is directed to an output operation. LA, CS, WR and RD are a address signal, a selection signal for the display unit 80, a write signal and a read signal, respectively.

A joint photographic experts group (JPEG) processor is configured by a line buffer interface 325, a second line buffer 327, a JPEG pixel interface 329, a JPEG controller 331, a JPEG core bus interface 333 and a JPEG code buffer 335. In an embodiment of the invention, the JPEG processor can be a JPEG codec. The JPEG processor compresses the image data received from the signal processor 60 into a JPEG format to output code data to the controller 10, or decompresses compressed code data received from the controller 10 into the JPEG format to output the decompressed data to the digital picture processor. In an embodiment of the present invention, the JPEG processor compresses YUV211 or YUV422 format-based image data based on a common intermediate format (CIF) size received from the CCD interface 311 or compresses scaled and cropped image data preferably of a size of 128×112 or 128×96 in the JPEG format, and then outputs code data. Code data received from the controller 10 is decompressed into the JPEG format and then the decompressed data is transmitted to the digital picture processor.

Next, an operation of the JPEG processor will be described.

The line buffer interface 325 applies the YUV211 format-based image data received from the CCD interface 311 to the second line buffer 327. The second line buffer 327 buffers or stores the received image data in units of lines. The JPEG pixel interface 329 provides, to the JPEG controller 331, the image data stored in the second line buffer 327 in units of lines. The JPEG controller 331 compresses the received image data and then outputs the compressed image data to the bus interface 333. Then, the JPEG controller 331 decompresses the compressed image data received from the bus interface 333 and then outputs the decompressed data to the pixel interface 329. The bus interface 333 serves as an interface between the JPEG controller 331 and the JPEG code buffer 335. The JPEG code buffer 335 buffers the JPEG image data received from the controller 10 through the JPEG controller 331 and the control interface 321.

A thumbnail processor is configured by a thumbnail resizer 337 and a thumbnail buffer 339. The thumbnail processor re-configures a thumbnail image from the image data outputted by the digital picture processor. It is assumed that the image data having a size of 128×112 or 128×96 outputted by the digital picture processor in an embodiment of the present invention is preferably reduced to a picture size of 40×40.

Where a display picture consists of the 128×112 pixels in an embodiment of the present invention, 14 pixels at each of left and right ends of the display picture are removed and 6 pixels at each of upper and lower ends of the display picture are removed wherein a picture having a size of 100×100 is provided. A picture having a size of 40×40 is created using a 5-2 pull down scheme. Where a display picture consists of the 128×96 pixels, 14 pixels at each of left and right ends of the display picture are removed. Accordingly, a picture consisting of 100×96 pixels is provided. Since the number of lines of the picture is not 100 lines, a picture having a size of 40×40 is provided using the 5-2 pull down scheme after processing insufficient 2 lines of upper and lower lines in the form of black lines.

The control interface 321 serves as an interface between the image processor 70 and the controller 10, and interfaces between the display unit 80 and the controller 10. That is, the control interface 321 serves as a common interface for accessing the register of the image processor 70, the JPEG code buffer 335, the thumbnail buffer 339 and for accessing the display unit 80 through the image processor 70. D<15:0> and A<1:0> indicate a data bus and an address bus, respectively. CS, WR, RD and SEL are a selection signal for the image processor 70 and the display unit 80, a write signal, a read signal and a control signal for the selector 319, respectively.

Under control of the controller 10, the selector 319 outputs data received from the image processor 70 or data received from the controller 10 to the display unit 80.

An I2C interface 323 allows the controller 10 to directly access the signal processor 60. That is, the I2C interface 323 controls the signal processor 60, and the controller 10 can access the signal processor 60 irrespective of the I2C interface 323, as in the case where data is read from a conventional register or written to the conventional register. SDA associated with the I2C interface 323 is I2C data for a CCD module, which is exchanged with the signal processor 60. SCL associated with the I2C interface 323 is an I2C clock for the CCD module.

An operation of the digital picture processor will now be described. The CCD interface 311 serves as an interface for the image data outputted by the signal processor 60. The image data is based on YUV211 (16 bits) and fixed to a CIF size of 352×288. In accordance with an embodiment of the present invention, the scaler 313 scales data of the image signals captured by the camera 50 in response to a control signal received from the controller 10, such that the scaled image data is displayed on the display unit 80. That is, the number of pixels of the image signals received from the camera 50 corresponds to the CIF size of 352×288, and the number of pixels of image signals capable of being displayed on the display unit 80 corresponds to a size of 128×112 or 128×96. Thus, the scaler 313 reduces and crops the pixels of the image signals received from the camera 50 to provide the number of the image signal pixels capable of being displayed on the display unit 80. Moreover, the scaler 313 can enlarge the pixels of the image signals received from the camera 50 such that the enlarged pixels can be displayed. In a method for enlarging and displaying the pixels, the pixels of the image signals received from the camera 50 are selected by the number of pixels capable of being displayed on the display unit 80 and the selected image signal pixels which can be displayed. The converter 315 converts YUV data received from the scaler 313 into RGB data and then outputs the RGB data. The LCD interface 317 serves as an interface for the image data of the display unit 80. The first line buffer 318 buffers the image data interfaced between the LCD interface 317 and the display unit 80.

An operation of capturing image signals through the camera 50 and displaying the captured image signals on the display unit 80 will now be described.

First, an operation of transmitting the image signals captured by the camera to the display unit 80 will be described.

The image processor 70 controls a transmission rate of image data received from the signal processor 60, and stores the received image data in the memory of the display unit 80 through the LCD interface 317. A size of image signals received from the CCD sensor is a CIF size of 352×288. Pixels of the image signals are reduced and partially removed or cropped such that the number of pixels capable of being displayed on the display unit 80 is created. The scaler 313 of the image processor 70 removes some pixels or selects pixels of a specified area such that the pixels received from the signal processor 60 can be displayed on the display unit 80. A flow of image data through the signal processor 60, the image processor 70 and the display unit 80 is affected by an access rate for the display unit 80. Thus, the LCD interface 317 supports a function of temporarily buffering the data in the first line buffer 318 such that a rate of the image data read from the signal processor 60 and a rate of the image data written to the display unit 80 can be adjusted.

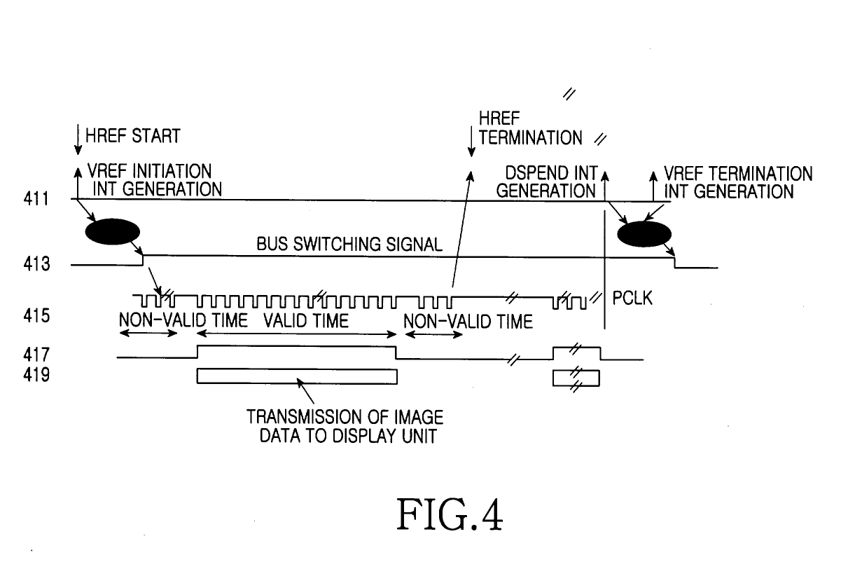

A method for processing the image data received from the image processor 70 in response to synchronous signals VREF and HREF from the CCD image sensor will now be described with reference to FIG. 4.

FIG. 4 is a data signal diagram illustrating an example of a procedure of transmitting an image signal from a camera in an image processing device in accordance with an embodiment of the present invention. As indicated by reference numeral 411 shown in FIG. 4, the controller 10 detects an interrupt signal at a rising time of the VREF signal. When detecting the VREF signal, the controller 10 activates a bus switching signal as indicated by reference numeral 413 shown in FIG. 4, and gives a bus use right to a CCD path of the image processor 70. Then, the controller 10 controls the selector 319 such that an output of the LCD interface 317 can be applied to the display unit 80. As described above, if the bus use right is given to the CCD path of the image processor 70, the image processor 70 generates a clock signal PCLK as indicated by reference numeral 415 shown in FIG. 4 and a horizontal valid section signal as indicated by reference numeral 417 shown in FIG. 4. In an embodiment of the invention, the horizontal valid section signal can be a horizontal synchronous signal HREF. Thus, as indicated by the reference numerals 415 and 417, the image processor 70 transmits the image data in units of lines. At this time, the image processor 70 transmits the image data in a valid time as indicated by reference numeral 419. Then, the selector 319 selects an output of the LCD interface 317, and the image data is transmitted to the display unit 80. Then, the display unit 80 stores the image data in an internal memory. If the image processor 70 completes the transmission of the predetermined number of pixels, the image processor 70 generates a DSPEND signal and then provides a transmission termination signal to the controller 10. The image processor 70 detects a VREF termination time, generates an interrupt signal indicating a VREF termination, and transmits the interrupt signal to the controller 10.

FIG. 4 shows a state that the DSPEND signal is first generated. However, the interrupt signal indicating the VREF termination can be first generated. If any signal is generated, the controller 10 detects the generated signal and the bus use right is provided to the controller 10. When the bus is coupled to the CCD path, the controller 10 cannot access the display unit 80. That is, while the data is transmitted through the CCD path, the controller 10 cannot access the display unit 80.

When image data is transmitted through the CCD path, the display unit 80 cannot be accessed. As described above, the controller 10 and the image processor 70 exclusively have a bus access for the display unit 80, respectively. Thus, a time for transmitting the image data in the CCD path is calculated, and the controller 10 preferably calculates an access time for accessing the display unit 80. The transmission time of the image data is determined by the frequency of a clock PCLK (a master clock) and a frame rate in the signal processor 60.

The scaler 313 of the digital picture processor scales a size of pixels of image signals captured by the camera 50 to a size of pixels of image signals capable of being displayed on the display unit 80. That is, the number of the pixels of the image signals corresponding to one frame captured by the camera 50 is different from the number of the pixels of the image signals corresponding to one frame capable of being displayed on the display unit 80. The case where the number of the pixels of the image signals corresponding to one frame captured by the camera 50 is larger than the number of the pixels of the image signals corresponding to one frame capable of being displayed on the display unit 80 will now be described. In this case, the number of pixels corresponding to one frame captured by the camera 50 is reduced to the number of pixels corresponding to one frame capable of being displayed on the display unit 80. A method can be used for appropriately setting the number of pixels of one frame and displaying the set number of pixels on the display unit 80. Where the number of the pixels is reduced, resolution can be degraded. On the other hand, where the number of pixels is appropriately set, pixels of a specified area can be selected from the captured image and hence an image of the selected pixels can be enlarged or zoomed out with keeping an appropriate resolution.

Otherwise, the number of pixels corresponding to one frame capable of being displayed on the display unit 80 can be larger than the number of pixels corresponding to one frame captured by the camera 50. In this case, an interpolating method for inserting pixels between pixels of the image signals captured by the camera 50 can be used. Pixels having an interpolated intermediate value can be inserted between the pixels of the image signals captured by the camera 50. Further, the pixels having the interpolated intermediate value can be inserted between lines.

A method for reducing an original image will now be described.

In an embodiment of the present invention, when the image data is transmitted from the signal processor 60 to the display unit 80, the image data is horizontally and vertically reduced such that 352×288 pixels corresponding to an CIF image received from the signal processor 60 can be inserted into a display area corresponding to 132×132 pixels.

The following Table 1 shows zoom-ratio setting commands for controlling the scaler 313. As shown in Table 1, a vertical/horizontal zoom-ratio setting command preferably has a parameter of one word. The scaler 313 preferably includes a straight-line interpolation filter in a horizontal direction and a device for extracting and processing pixels in a vertical direction. In an embodiment of the present invention, picture processing can be horizontally and vertically adjustable in 256 steps of 1/256˜256/256.

TABLE 1
SCALE parameter (R/W)

| A<1:0> | D<15:8> | D<7:0> | Default |
|---|---|---|---|
| 3h | H_SCALE | V_SCALE | 6464h |

In the above Table 1, H_SCALE is a scale ratio setting parameter in a horizontal direction, and a scale ratio=(H_SCALE+1)/256. V_SCALE is a scale ratio setting parameter in a vertical direction and a scale ratio=(V_SCALE+1)/256. For example, where H_SCALE=V_SCALE=150, (150+1)/256=0.5898. In this case, reduction processing of “×0.5898” for an original image (CIF: 352×288) is carried out.

Next, an operation of selecting pixels corresponding to a display area of the display unit 80 and performing a zoom function will be described. In this case, horizontal and vertical valid sections is preferably set.

The following Table 2 shows a command (HRANG) for setting a horizontal display initiation position/valid display section. The command preferably has a parameter of one word. After a scaling operation is performed in response to the command parameter as shown in the following Table 2, a corresponding picture is horizontally cropped to be appropriate to a display size of the display unit 80.

TABLE 2
HRANG parameter (R/W)

| A<1:0> | D<15:8> | D<7:0> | Default |
|---|---|---|---|
| 3h | H_ST | H_VAL | 240h |

In the above Table 2, H_ST is a parameter for setting a display initiation position in the vertical direction, and H_VAL is a parameter for setting a valid display section in the horizontal direction. Actual values of H_ST and H_VAL are a set value×2, respectively.

The following Table 3 shows a command (VRANG) for setting a vertical display initiation position/valid display section. The command preferably has a parameter of one word. After a scaling operation is performed in response to the command parameter, a corresponding picture is vertically cropped to be appropriate to a display size of the display unit 80.

TABLE 3
VRANG parameter (R/W)

| A<1:0> | D<15:8> | D<7:0> | Default |
|---|---|---|---|
| 3h | V_ST | V_VAL | 0038h |

In the above Table 3, V_ST is a parameter for setting a display initiation position in the vertical direction, and V_VAL is a parameter for setting a valid display section in the horizontal direction. Actual values of V_ST and V_VAL are a set value×2, respectively.

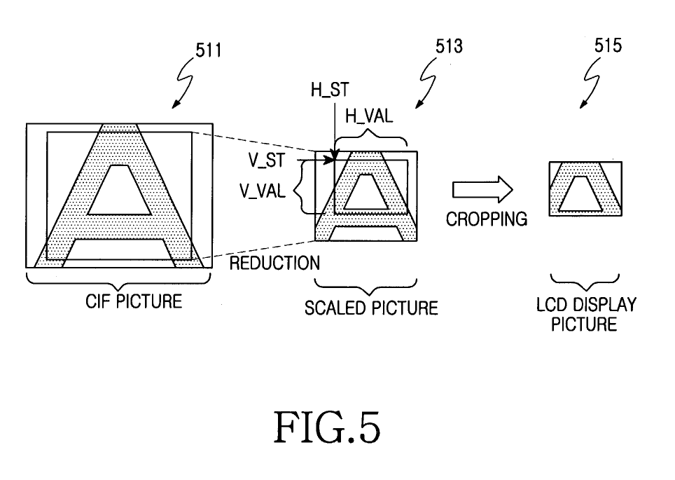

Thus, where the signal processor 60 outputs image data as indicated by a reference numeral 511 shown in FIG. 5, a scaled picture indicated by a reference numeral 513 shown in FIG. 5 is generated and a display picture indicated by a reference numeral 515 shown in FIG. 5 is generated by cropping the scaled picture, if the horizontal valid section associated with the above Table 2 and the vertical valid section associated with the above Table 3 are set.

When a size of pixels of image signals corresponding to one screen captured by the camera 50 is different from a size of pixels of image signals corresponding to a screen capable of being displayed, the controller 10 generates a first scale control signal for reducing the pixels of the image signals captured by the camera 50 in response to the user's selection and displaying the reduced pixels on the entire screen of the display unit 80, and a second scale control signal for selecting a predetermined pixel area of the image signals captured by the camera 50 and displaying the selected pixel area on a zoom screen. In response to the first or second scale control signal, the scaler 313 reduces the pixels of the image signals captured by the camera 50 or selects a predetermined pixel area of the image signals captured by the camera 50 containing pixels capable of being displayed on the display unit 80, such that the scaler 313 outputs the reduced pixels or the selected pixels.

In accordance with an embodiment of the present invention as described above, it is assumed that the pixels of the image signals captured by the camera 50 corresponds to a CIF size of 352×288, and the number of pixels of image signals capable of being displayed on the display unit 80 corresponds to a size of 128×112 or 128×96. It is assumed that a zoom ratio is (scale value+1)/256 if the picture processing can be horizontally and vertically adjustable in 256 steps of 1/256˜256/256.

First, where the CIF size of 352×288 is reduced to a size of 128×96 corresponding to the display unit 80, the scale value can be represented by the following.

Scale value=zoom ratio*256−1=128/352*256−1=92

Further, where a maximum zoom ratio is used, the scale value is represent by the following.

Scale value=1*256−1=255*74

The zoom ratio can be calculated by the following.

Maximum zoom ratio/minimum zoom ratio=1/(128/352)=2.75

As described above, where a first screen is displayed, one pixel is extracted from CIF input 352*288 pixels every 256/(scale value+1) pixels according to the scale value and extracted pixels are outputted to the display unit 80. Where the scale value is 99, 256/(99+1)=2.56. One pixel is extracted from the CIF pixels every 2.56 pixels, and extracted pixels are outputted to the display unit 80. Through the above-described method, the scaler reduces and crops pixels of the image signals captured by the camera 50 to the number of pixels capable of being displayed on the display unit 80.

Hereinafter, it is assumed that the mobile communication terminal is equipped with the camera 50.

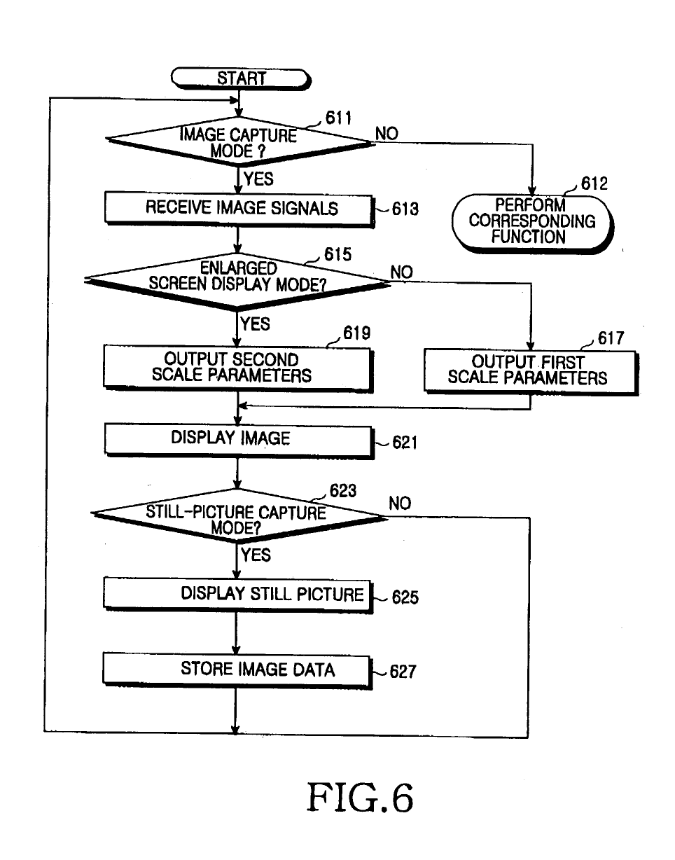

FIG. 6 is a flow chart illustrating an example of steps for performing for a zoom function in the image processing device in accordance with the present invention.

Referring to FIG. 6, where an image of captured image signals is displayed on the display unit 80, the user generates key data for driving the camera 50 via the keypad 27. At this time, a key for operating an image capture mode can be arranged on a navigation key of the keypad 27. In an embodiment of the invention, the key for driving the image capture mode can be displayed and selected as a menu item using a menu key. When the image capture mode is selected, the controller 10 detects the selected image capture mode at step 611. The controller 10 activates a channel capable of receiving the captured image signals by controlling the signal processor 60 and the image processor 70, and receives the captured image signals from the camera 50 by controlling the signal processor 60 at step 613.

At step 612, if the image capture mode is not selected, the mobile terminal can perform a corresponding function, for example, be in a standby mode, establish a call and so on.

At step 615, the controller 10 determines whether a display mode for displaying image signals captured by the camera 50 has been set. The display mode includes a first screen display mode for reducing the number of pixels of the captured image signals and displaying the reduced pixels on a first screen, and a second screen display mode for selecting pixels of a predetermined area from the pixels of the image signals and displaying the selected pixels on a zoom screen. When the second screen display mode is not selected in the image capture mode, the first screen display mode is automatically selected. Meanwhile, when the second screen display mode is set, parameters for setting the pixels of the predetermined area from the pixels of the image signals is preferably set. That is, when the second screen display mode is selected, the controller 10 preferably outputs commands associated with position setting parameters as shown in the above Table 2 and Table 3. The parameters include a parameter H_ST for setting a horizontal display initiation position, a parameter H_VAL for setting a horizontal valid display section, a parameter V_ST for setting a vertical display initiation position, a parameter V_VAL for setting a vertical valid display section, and so on. To indicate the parameters for the second display screen, the controller 10 sets the parameters for a first screen display area corresponding to the captured image signals of one screen and stores the set parameters in the memory 29. When the second display image mode is selected in the first display image mode, the controller 10 performs a control operation such that information of a selectable second screen display area containing preset location information stored in the memory 29 can be displayed in a menu and selected. Further, if the user designates horizontal and vertical display initiation positions, the controller 10 calculates values of horizontal and vertical valid display sections and then outputs the parameters as shown in the above Table 2 and Table 3.

Thus, if the first screen display mode is selected in a state that the menu indicating the screen display modes is displayed at the above step 615, the controller 10 generates the parameters associated with the first screen as shown in the above Table 1 and then outputs the generated parameters to the scaler 313 at step 617. In the above Table 1, H_SCALE is a scale ratio setting parameter in a horizontal direction, and a scale ratio=(H_SCALE+1)/256. V_SCALE is a scale ratio setting parameter in a vertical direction and a scale ratio=(V_SCALE+1)/256.

If the second screen display mode is selected when the menu indicating the image display modes is displayed at the above step 615, the controller 10 generates second scale parameters associated with the second screen and then outputs the generated parameters to the scaler 313 at step 619. The second scale parameters include parameters associated with horizontal and vertical display initiation positions and horizontal and vertical valid display sections as shown in the above Table 2 and Table 3.

Methods for generating the second scale parameters are as follows. In the first method, if the controller 10 generates a second scale control signal, the scaler 313 selects pixels of a specified area from a received CIF picture, and outputs the selected pixels as image data of the second display screen. That is, the first method selects and outputs the pixels of the specified area from the received CIF picture. Moreover, this method fixedly selects the specified area. The second method stores data of the pre-set second screen display area in the memory 29 and allows the user to select and display the second screen display area when the screen display mode is selected. The third method allows the user to set the horizontal and vertical initiation positions associated with the second screen in a state that the CIF image is displayed. Any method selected from the group consisting of the first, second and third methods can be used.

Thus, if the user selects the second screen display mode at the above step 615, the controller 10 detects the selected second screen display mode, generates the second scale parameters as shown in the above Table 2 and Table 3 in response to the selection of the second scale parameters, and outputs the generated scale parameters to the scaler 313 at step 619. The scaler 313 selects the second screen based on the second scale parameters and indicated by the reference numeral 513 from the first screen indicated by the reference numeral 511 as shown in FIG. 5, and then outputs a display picture indicated by the reference numeral 515 shown in FIG. 5.

After performing the above step 619 or 617, the controller 10 controls the signal processor 60 and the image processor 70 such that the image signals captured by the camera 50 can be displayed at step 621. The displayed image signals correspond to a preview screen as a moving picture. Where the image signals of the 15 frames per second are displayed on the preview screen in the normal mode, an appropriate moving picture is displayed.

The user can identify the displayed moving picture and generate a still-picture capture command to obtain a still picture at a specified time, where a preview image is displayed. The still-picture capture command can be generated using a specified function key arranged on the keypad 27 or selected using a menu key. If the still-picture capture command is generated, the controller 10 detects the generated still-picture capture command at step 623, and captures a still picture from currently displayed image pictures by controlling the image processor 70 at step 625. At step 627, the controller 10 reads image data of the still picture, stores the read image data in an image memory area contained in the memory 29, and returns to step 611.

As apparent from the above description, the present invention provides a method for displaying an image, which operates the first screen display mode, scales a CIF picture of image signals captured by the camera 50, reduces the scaled CIF picture on the basis of a display area of the display unit 80, selects information of the second screen corresponding to a specified area of the first screen when the user enables the second screen display mode and the scale control signal, and displays the second screen in the form of a zoom screen.

Where a size of an image corresponding to image signals captured by a camera is different from a size of an image capable of being displayed on the display unit, an image processing device reduces the image based on the captured image signals in response to a user's selection to display the reduced image on an entire screen, or selects pixels of a specified area from the image based on the captured image signals according to a size of a screen of the display unit to display the selected pixels on a zoom screen.

Although several embodiments of the present invention have been disclosed for illustrative purposes, those skilled in the art will appreciate that various modifications, additions and substitutions are possible, without departing from the scope of the invention. Accordingly, the present invention is not limited to the above-described embodiments, but the present invention is defined by the claims which follow, along with their full scope of equivalents.

What is claimed is:

1. A device for displaying an image in a mobile communication terminal including a camera for capturing image signals, and a display unit for displaying the image having a size different from a size of an image of the captured image signals, comprising:
a keypad having keys for providing an image capture mode and screen display modes;
a controller for generating an image capture control signal when an image capture mode key is inputted, and generating first and second scale control signals respectively corresponding to first and second screen display mode keys;
a signal processor for processing the image signals received from the camera in a digital format when the image capture control signal is generated; and
an image processor for generating image data based on a screen size of the display unit by reducing pixels of the image signals processed by the signal processor when the first scale control signal is generated, generating image data based on the screen size of the display unit by selecting pixels corresponding to the screen size at set horizontal and vertical display initiation positions when the second scale control signal is generated, and outputting the image data to the display unit.

2. The device as set forth in claim 1, wherein the image processor comprises:
a picture processor having a scaler for scaling the image signals processed by the signal processor in response to the scale control signal;
a joint photographic experts group (JPEG) processor for compressing and decompressing the image signals outputted by the picture processor into a JPEG format; and
a thumbnail processor for reducing the image signals outputted by the picture processor to image data having a size of a thumbnail screen.

3. The device as set forth in claim 2, wherein the first scale control signal comprises a horizontal scale parameter for setting a scale ratio in a horizontal direction and a vertical scale parameter for setting a scale ratio in a vertical direction.

4. The device as set forth in claim 3, wherein the horizontal scale parameter comprises a scale ratio=(H_SCALE+1)/256, and the vertical scale parameter comprises a scale ratio=(V_SCALE+1)/256.

5. The device as set forth in claim 2, wherein the second scale control signal comprises a parameter for setting a horizontal display initiation position, a parameter for setting a horizontal valid display section, a parameter for setting a vertical display initiation position, and a parameter for setting a vertical valid display section.

6. A method for displaying an image in a mobile communication terminal including a camera and a display unit having a display size different from a size of an image of the image signals captured by the camera, comprising the steps of:
(a) reducing pixels of the image signals captured by the camera in an image capture mode and displaying the reduced pixels based on a screen size of the display unit; and
(b) selecting some pixels of a predetermined area from the pixels of the captured image signals and displaying the selected pixels on a zoom screen, when a scale control signal is generated at the step (a).

7. The method as set forth in claim 6, wherein the scale control signal comprises a parameter for setting a horizontal display initiation position, a parameter for setting a horizontal valid display section, a parameter for setting a vertical display initiation position, and a parameter for setting a vertical valid display section.

8. A method for displaying an image in a mobile communication terminal including a camera and a display unit having a display size different from a size of an image of image signals captured by the camera, comprising the steps of:
(a) allowing the camera to capture the image signals;
(b) reducing pixels of the image signals captured by the camera according to a screen size of the display unit and displaying the reduced pixels when a first scale control signal is generated; and
(c) selecting some pixels of a predetermined area from the pixels of the captured image signals and displaying the selected pixels on a zoom screen, when a second scale control signal is generated.

9. The method as set forth in claim 8, wherein the first scale control signal comprises a horizontal scale parameter for setting a scale ratio in a horizontal direction and a vertical scale parameter for setting a scale ratio in a vertical direction.

10. The method as set forth in claim 8, wherein the second scale control signal comprises a parameter for setting a horizontal display initiation position, a parameter for setting a horizontal valid display section, a parameter for setting a vertical display initiation position, and a parameter for setting a vertical valid display section.
